(19) United States
(12) Patent Application Publication
(10) Pub. No.: US 2002/0127049 A1
(43) Pub. Date: Sep. 12, 2002

(54) Device for the releasable, adhesive-free connection of articles in sheet form

(76) Inventor: Karl Pircher, Vienna (AT)

Correspondence Address: LORUSSO & LOUD, 440 Commercial Street, Boston, MA, 02109, US

(21) Appl. No.: 09/839,484

(22) Filed: Apr. 20, 2001

(30) Foreign Application Priority Data
Mar. 12, 2001 (AT) GM179/2001

(51) Int. Cl. F16B 1/00; F16D 1/00; F16D 3/00

(52) U.S. Cl. 403/169

(57) ABSTRACT

A device for the releasable, adhesive-free connection of at least two—in particular flexible—articles (6) in sheet form—in particular sheets of paper and/or pieces of card and/or photographs, wherein the device has at least two clamping means (2)—preferably arranged at different ends of the device—for receiving the articles (6) in sheet form.

The present invention concerns a device for the releasable, adhesive-free connection of at least two—in particular flexible—articles in sheet form—in particular sheets of paper and/or pieces of card and/or photographs.

Adhesives or adhesive strips are frequently employed for making montage assemblies of pictures or photographs or the like. They suffer firstly from the disadvantage that a connection made by means of adhesive can generally no longer be released again or when that connection is released the glued articles are at least partially damaged. In addition, glueing photographs or pictures involves a considerable amount of time and trouble if spatial three-dimensional bodies are to be produced by assembling different photographs and pictures. An alternative to an adhesive connection which can no longer be released is represented, in the state of the art, by clothes-pegs or crocodile clips which are similar thereto. They however are really not primarily provided for that function and generally spoil the overall aesthetic impression of the overall configuration which is assembled from pictures or photographs. In addition, they suffer from the disadvantage that pictures or photographs can be fitted into them only from one direction.

Therefore the object of the present invention is to provide a device which permits the three-dimensional assembly of in particular flexible articles in sheet form in a simple and aesthetic fashion. The invention also seeks to provide that release of those connections is possible without damaging or adversely affecting the in particular flexible articles in sheet form.

In accordance with the invention that is achieved in that the device has at least two clamping means—which are preferably arranged at different corners of the device—for receiving the articles in sheet form.

Articles in sheet form can be clamped in those clamping means. In that respect, the clamping means are shaped in such a way that, when the article in sheet form is subsequently released again, it does not suffer from partial or complete destruction. The arrangement of at least two clamping means for receiving the articles in sheet form at different corners of the device makes it possible for a sequence of articles in sheet form to be assembled in one plane but also in the form of a three-dimensional body, in an aesthetically pleasing manner. The devices according to the invention thus serve as modular components with which articles in sheet form such as for example photographs can be assembled together. In that respect there are variants with which articles in sheet form can be clipped together to form strips and surfaces (for example to form curtains, wall pictures, draught or folding screens, door chains and so forth). In addition, it is also possible to compose three-dimensional bodies (such as for example lamps, chandeliers, crowns, architectural designs, sculptures and so forth).

It is particularly desirable in that respect for at least one clamping means to be elastically deformable, in which case at least one article in sheet form can be clamped fast to the clamping means by virtue of the resilient return forces of the clamping means. The article in sheet form is thus held by friction in the clamping means preferably between two clamping legs and can be removed again if necessary without any problem. That kind of clamping means is on the one hand a structurally very simple design configuration for attaining the object of the invention while on the other hand this kind of clamping means can be made in very small dimensions so that the aesthetics of the overall impression for example of the assembled pictures or the assembled photographs is not spoilt.

It is particularly desirable in that respect for the device to be of a one-piece and joint-less design configuration. This structurally very simple configuration markedly increases the longevity of the device as there are no movable parts thereon.

It is particularly desirable for at least one clamping means to have at least one insertion opening into which at least one article in sheet form can be introduced. In that respect, for assembling flat or three-dimensional arrangements of articles in sheet form, it is particularly desirable for the device to have two mutually oppositely disposed clamping means whose insertion openings face away from each other.

For the purposes of forming three-dimensional spatial montage arrangements it is particularly desirable for the device to have a connecting means which is preferably arranged between two clamping means, wherein at least one coupling means of at least one further clamping means can be mounted to the connecting means, preferably releasably and/or movably and/or rotatably. This further clamping means which can be mounted to the device basically provides a great degree of freedom in terms of the production of three-dimensional bodies from articles in sheet form. Thus for example intermediate planes or levels can be incorporated into a three-dimensional body or it is possible to implement arrangements of articles in sheet form, wherein the articles are in part substantially perpendicular to each other. In addition, freedom in particular in terms of shape and form is permitted by the further clamping means being mounted movably and/or rotatably to the device. In that respect particularly advantageous embodiments provide that the coupling means is substantially in the form of a ball and the connecting means is in the form of a socket of undercut configuration, preferably in the centre between at least two clamping means.

It is desirable in that respect that at least one coupling means of at least one further clamping means can be inserted into at least one connecting means, preferably forming a movable connection. For the purposes of forming corners with articles in sheet form which converge in mutually perpendicular relationship, it is particularly desirable for at least one further clamping means—preferably at least one insertion opening of at least one further clamping means—to be arranged substantially perpendicularly to the other clamping means—preferably substantially perpendicularly to at least one insertion opening of the other clamping means.

An advantageous variant of the clamping means provides that at least one clamping means and/or at least one further clamping means has at least two clamping legs, wherein at least one slot-like opening is arranged between at least two clamping legs, wherein at least one article in sheet form can be introduced into the slot-like opening. In this case, in an advantageous embodiment, retention of an article in sheet form in the slot-like opening is improved by virtue of the fact that at least one slot-like opening is of a wavy or corrugated configuration in at least one side view. In that respect it is further advantageous for the slot-like opening to be substantially closed when no article in sheet form has been introduced into same. The durability of the device is increased in an advantageous embodiment by virtue of the fact that at least one end which faces into the device of at least one slot-like opening is in the form of a round bore which extends parallel to the slot-like opening. That ensures, even after multiple use of the device, that the slot-like opening does not tear further open and as a result the device is not destroyed. An advantageous embodiment provides that at least two slot-like openings of at least two clamping means are disposed substantially in one plane. Desirable embodiments further provide that the greatest dimension thereof is between 0.5 and 5 cm, preferably between 0.5 and 3 cm. A particularly advantageous embodiment provides that the largest dimension of the device is 2 cm. For the purposes of economic production of the device according to the invention on an industrial scale it is particularly desirable for the device to comprise at least one plastic injection moulding.

Further features and details of the present invention will be apparent from the specific description hereinafter. In the drawing:

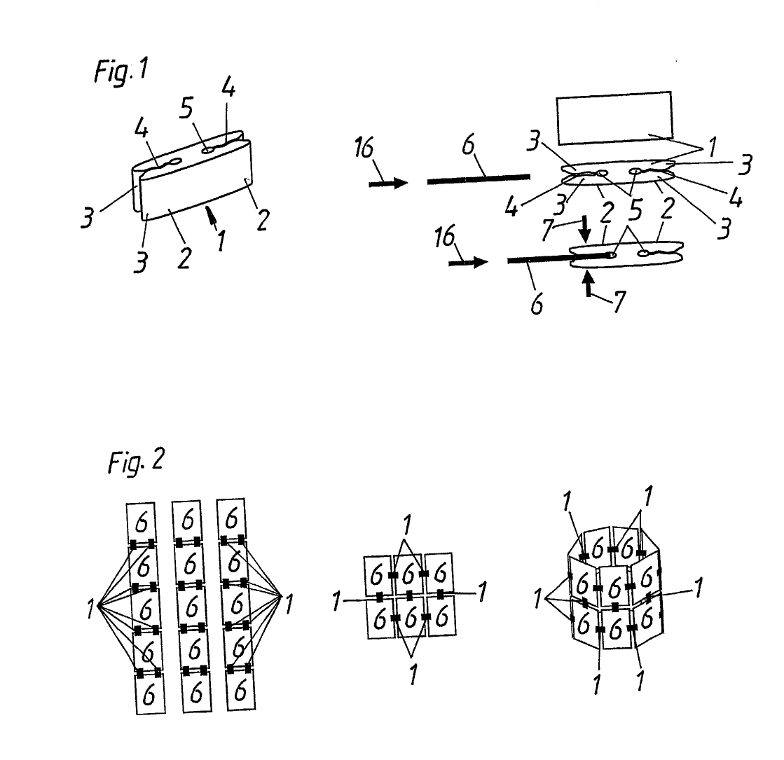

FIG. 1 shows various views of an embodiment with two slot-like openings arranged substantially in one plane,

FIG. 2 shows various examples of arrangements of articles in sheet form by means of the embodiment illustrated in FIG. 1,

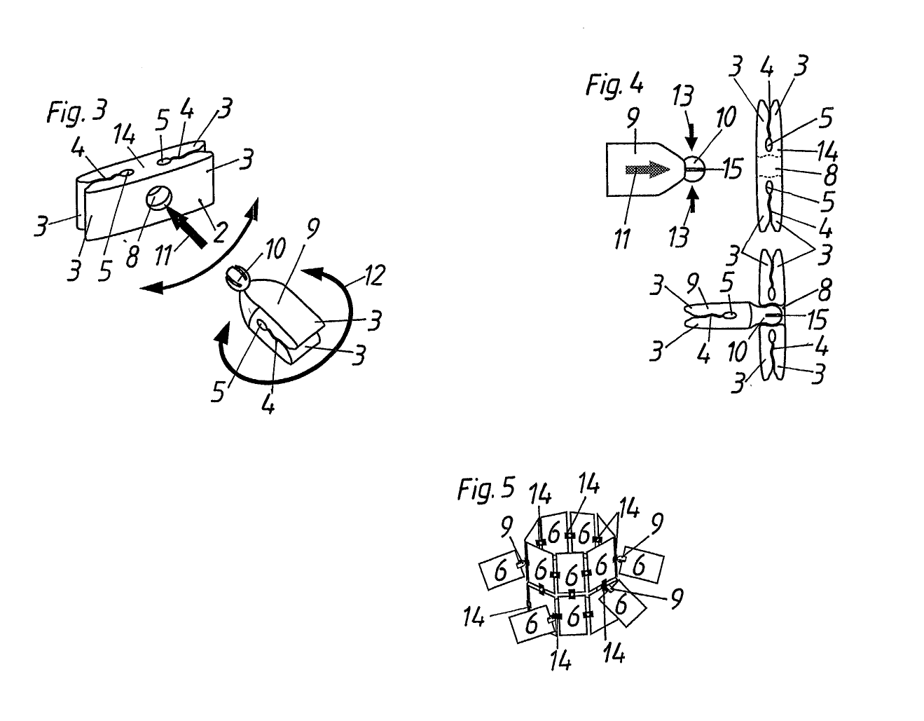

FIG. 3 shows an embodiment of a device according to the invention with a further clamping means,

FIG. 4 shows side views of the embodiment shown in FIG. 3, and

FIG. 5 shows an example of use of the embodiment of FIG. 3 for implementing a three-dimensional arrangement of articles in sheet form by means of the embodiment illustrated in FIG. 3.

FIG. 1 shows an embodiment 1 of the device according to the invention with two clamping means 2. The embodiment 1 is made in one piece for example by injection moulding. A clamping means 2 has substantially two clamping legs 3 and a slot-like opening 4 which is disposed therebetween. The slot-like opening 4 is respectively closed off by a bore 5 which extends parallel thereto. In the case of the device according to the invention, it is provided that for example a sheet 6 is inserted into the slot-like opening 4 of the device 1, in the direction indicated by the arrow 16. The article 6 in sheet form is held by means of friction in the slot-like opening 4 by virtue of the resilient return forces of the clamping means 2, which act in the direction 7. If necessary an article 6 in sheet form which is clamped in position in that way can be pulled out of the slot-like opening 4 of the clamping means 2 again without the article 6 in sheet form being adversely affected or even destroyed.

FIG. 2 shows the way in which a plurality of sheet-like articles 6, for example photographs, can be connected firstly in a row but also in a plane by the embodiments 1 of the device according to the invention. Beside this arrangement of pictures or photographs, which is shown in the left-hand and middle part in FIG. 2, the right-hand part in FIG. 2 shows how the embodiment 1 of the device according to the invention can be used to produce a three-dimensional arrangement of sheet-like articles 6.

FIG. 3 shows an embodiment 14 of the device according to the invention, to the connecting means 8 of which can be fitted a further clamping means 9 by means of the coupling means 10 thereof. In this respect the structure of the embodiment 14 shown in FIG. 3 is substantially the same as the structure of the embodiment shown in FIG. 1. The difference lies essentially in the connecting means 8 which is fitted into the main body of the embodiment 14 in the centre between the two clamping means 2 in the form of a socket of undercut configuration. Similarly to the embodiment 14 the further clamping means 9 firstly has clamping legs 3, a slot-like opening 4 and a bore 5 extending parallel to the slot-like opening 4. The coupling means 8 is arranged at the end of the further clamping means 9, which is in opposite relationship to the first clamping means. The coupling means 10 is here substantially in the form of a ball. The coupling means 10 can be introduced into the connecting means 8 of the embodiment 14 in the direction indicated by the arrow 11. After the further clamping means 9 has been introduced in the manner illustrated the clamping means 9 is still rotatable in the direction of the arrow 12, and also pivotable within certain limits.

FIG. 4 shows a side view of the further clamping means 9 and the embodiment 14 in which the further clamping means 9 has not yet been introduced into the connecting means 8 of the embodiment 14. When the further clamping means 9 is coupled to the connecting means 8 the coupling means 10 which is in the form of a ball is compressed in the direction of the arrows 13, whereby the gap 15 in the coupling means 10 is compressed upon being introduced. When the further clamping means 9 has been introduced into the connecting means 8, as shown in the lower view in FIG. 4, the resilient return forces of the coupling means 10, which act in the opposite direction to the arrows 13, hold the further clamping means 9 clamped in position in the embodiment 14. The lower view in FIG. 4 is a sectional illustration of the embodiment 14.

FIG. 5 shows use of the embodiment 14 with an additional clamping means 9 coupled therein. Use of the further clamping means 9 and the embodiment 14 provides that additional articles 6 in sheet form can also be mounted to the three-dimensional arrangement of articles in sheet form, which is illustrated in FIG. 2, as shown by way of example in FIG. 5. The methods of use of the embodiments 1 and 14 and the further clamping means 9, illustrated in the drawing, are not limited to the illustrated examples. On the contrary the illustrated examples only serve to give the viewer an impression of the possible options of the arrangement of for example pictures or photographs by means of the device according to the invention.

1. A device for the releasable, adhesive-free connection of at least two articles in sheet form, characterised in that the device has at least two clamping means for receiving the articles in sheet form.

2. A device according to claim 1 characterised in that at least one clamping means is elastically deformable, wherein at least one article in sheet form can be clamped fast to the clamping means by virtue of the resilient return forces thereof.

3. A device according to claim 1 characterised in that the device is formed in one piece and without joints.

4. A device according to claim 1 characterised in that at least one clamping means has at least one insertion opening into which at least one article in sheet form can be introduced.

5. A device according to claim 1 characterised in that the device has two mutually oppositely disposed clamping means whose insertion openings face away from each other.

6. A device according to claim 1 characterised in that the device has a connecting means, wherein at least one coupling means of at least one further clamping means can be mounted to the connecting means.

7. A device according to claim 6 characterised in that the coupling means is substantially in the form of a ball.

8. A device according to claim 6 characterised in that the connecting means is in the form of a socket of undercut.

9. A device according to claim 1 characterised in that at least one coupling means of at least one further clamping means can be inserted into at least one connecting means.

10. A device according to claim 6 characterised in that at least one further clamping means is arranged substantially perpendicularly to the other clamping means.

11. A device according of claim 1 characterised in that at least one clamping means and at least one further clamping means has at least two clamping legs, wherein at least one slot-like opening is arranged between at least two clamping legs, wherein at least one article in sheet form can be introduced into the slot-like opening.

12. A device according to claim 11 characterised in that at least one slot-like opening is of a wavy configuration in at least one side view.

13. A device according to claim 11 characterised in that the slot-like opening is substantially closed when no article in sheet form is introduced into same.

14. A device according to claim 11 characterised in that at least one end, which faces into the device, of at least one slot-like opening is in the form of a round bore extending parallel to the slot-like opening.

15. A device according to claim 11 characterised in that at least two slot-like openings of at least two clamping means are disposed substantially in one plane.

16. A device according to claim 1 characterised in that its largest dimension is between 0.5 and 5 cm, preferably between 0.5 and 3 cm.

17. A device according to claim 1 characterised in that its largest dimension is 2 cm.

18. A device according to claim 1 characterised in that it comprises at least one plastic injection moulding element.

19. A device according to claim 1 characterised in that the at least two articles in sheet form are sheets of paper.

20. A device according to claim 1 characterised in that the at least two articles in sheet form are pieces of card.

21. A device according to claim 1 characterised in that the at least two articles in sheet form are photographs.

22. A device according to claim 1 characterised in that the at least two clamping means are arranged at different ends of the device.

23. A device according to claim 6 characterised in that a connecting means is preferably arranged between at least two clamping means.

24. A device according to claim 6 characterised in that at least one coupling means of at least one further clamping means can be mounted to the connecting means releasably.

25. A device according to claim 6 characterised in that at least one coupling means of at least one further clamping means can be mounted to the connecting means movably.

26. A device according to claim 6 characterised in that at least one coupling means of at least one further clamping means can be mounted to the connecting means rotatably.

27. A device according to claim 8 characterised in that the connecting means is in the centre between at least two clamping means.

28. A device according to claim 6 characterised in that at least one coupling means of at least one further clamping means can be inserted into at least one connecting means by forming a movable connection.

29. A device according of claim 8 characterised in that at least one clamping means or at least one further clamping means has at least two clamping legs, wherein at least one slot-like opening is arranged between at least two clamping legs, wherein at least one article in sheet form can be introduced into the slot-like opening.
